(19) United States
(12) Patent Application Publication
(10) Pub. No.: US 2010/0088805 A1
(43) Pub. Date: Apr. 15, 2010

(54) ELASTIC INSERT, METHOD FOR THE PRODUCTION AND USE THEREOF

(75) Inventors: Ulrich Scherbel, Muenchen (DE); Antje Gerlicher, Muenchen (DE)

Correspondence Address: SCULLY SCOTT MURPHY & PRESSER, PC, 400 GARDEN CITY PLAZA, SUITE 300, GARDEN CITY, NY, 11530, US

(73) Assignee: KUFNER TEXTIL GMBH, Muenchen (DE)

(21) Appl. No.: 12/526,400

(22) PCT Filed: Jan. 31, 2008
(86) PCT No.: PCT/EP2008/051192

§ 371 Date: Oct. 8, 2009

(30) Foreign Application Priority Data
Feb. 9, 2007 (DE) 10 2007 006 568.1

(51) Int. Cl. A41D 27/06; B05D 5/10; D04B 1/00; D06M 23/00

(52) U.S. Cl. 2/255; 427/207.1; 442/314; 8/494

(57) ABSTRACT

The invention relates to an elastic (fixing) insert made of a carrier based on knit fabric, wherein the knit fabric is produced from at least two warp thread systems, with at least one of said warp thread systems being inserted in the knit fabric as a partial weft and comprising staple fiber yarns. One side of the knit fabric is provided with an adhesive layer. The resulting insert exhibits very high elasticity in the longitudinal, transversal and diagonal directions and is particularly cost-effective to produce. Furthermore, it is characterized by a very soft, textile feel and a good appearance.

This invention relates to an elastic insert, in particular an elastic fixing insert based on a knitted fabric and a method for the production and use thereof.

Inserts have been used for many years in the clothing industry, mainly for the reinforcement of the front part of items of clothing or for the reinforcement of collars and cuffs. These inserts comprise a substrate, which may be designed as a woven fabric, knitted fabric or also as a non-woven fabric and from a generally thermoplastic adhesive paste, which is napped in the form of a grid, wherein this adhesive paste makes it possible to bond with the outer fabric of the items of clothing.

The purpose of inserts of this kind is to endow the item of clothing with correct shape and to stabilise it. As they are bonded with the outer fabric, they influence the character of the finished item of clothing in a decisive manner. The look, shape retention, softness, wearing comfort and care properties during cleaning and washing are decisively dependent upon the nature and structure of the inserts used. Hereby, particularly important properties of the items of clothing are the look, feel and care properties of the finished item of clothing.

In addition, the items of clothing must comply with changing fashion trends. For this reason an extremely wide variety of outer fabrics are used. Accordingly, as a rule different types of inserts are also used to reinforce these different outer fabrics.

In principle, knitted fabrics are already used as substrate materials for insert materials. In this case, usually staple fibre yarns comprising viscose (CV), cotton (CO), polyester (PES), polyacrylonitrile (PAN) or mixtures thereof are used for the weft. The warp usually comprises filament yarns which preferably comprise polyester or polyamide and have fineness in the range of from 15 dtex to 78 dtex. The weight of inserts of this kind is usually within the range of from 35 to 140 g/m². The knitted fabrics produced can, for example, be thermally shrink-stabilised. It is also possible to nap or emerise one side of the cloth to produce a fibre pile which is as dense as possible on the surface of the insert and hence achieve a high degree of softness and volume and a densely woven character of the insert. Although inserts of this kind are very soft, the elasticity is not sufficient, in particular when non-elastic staple fibre yarns are used.

The application of an adhesive paste, preferably a thermoplastic hot-melt adhesive, is performed in accordance with a conventional method. When the insert is bonded to the outer fabric of the item of clothing, the fibre pile on the reverse side prevents the penetration of the hot-melt adhesive through the insert in the direction of the side of the lining fabric.

It is also known how to produce inserts from textured yarns in order to achieve volume and softness. For this, the yarns are created by special texturing methods. However, the drawback with inserts of this kind is the fact that the yarns created from two thread systems are also not elastic and that the formation of a loop structure can also result in entanglement of the lengths of cloth. In addition, an unsettled and uneven surface cannot be easily coated using a common coating method, namely the paste-scatter double-point method. Therefore, post-treatment is required in order to obtain a more uniform fabric surface which can then be coated again in accordance with the conventional method. An insert using air-textured materials is known for example from EP-A-0 810 314.

Another insert using false-twist textured polyester filament yarns has also been developed in recent years. These polyester filament yarns are used as weft yarns and the warp can be assembled in a similar way to that described above for the known inserts. Inserts of this kind are described for example in DE 93 198 70 U1.

The properties of fixing inserts of this kind are decisively characterised by the properties of the textured, particularly false-twist textured, filament yarns. Fixing inserts made of false-twist textured polyester filament yarns are highly elastic because they stretch very easily in the warp and weft directions in the event of tensile stresses and in slanting-off. This elasticity enables the insert to follow the dimensional changes of the outer fabrics caused by heat, during washing, due to solvents when cleaning or due to external forces.

A competitively priced elastic insert has been further developed and is described for example in DE 199 04 265 A1. An insert of this kind has the low shrinkage values and good care properties of the inserts made of false-twist textured PES filaments and combines these advantageous properties with the soft feel of a conventional napped insert. An insert of this kind is made of filaments, wherein the raw material produced (woven fabric or knitted fabric) is napped by emerising for example. This enables the production of a soft and also elastic insert.

However, there is also a requirement for further inserts which are particularly simple and inexpensive to produce which combine the advantages of the textured, elastic inserts with those of rigid napped inserts and even have similarly high elasticity to that of the known inserts or in which the elasticity can even be further improved.

Surprisingly, it was established that an insert of this kind can be provided by a substrate based on a knitted fabric assembled from at least two and preferably two to three warp thread systems, wherein at least one of these warp thread systems is inserted as a partial weft in the knitted fabric and contains staple fibre yarns. An insert of this kind is characterised by a very soft textile feel, a good appearance and high elasticity values of up to a maximum of 50% in the weft direction and approximately 10% in the warp direction. Values of this kind can be further improved by the (co-) use of textured threads, in particular false-twist textured filaments even in the partial weft.

Therefore, according to the invention the high elasticity and stretchability of a fixing insert in particular in the weft direction is achieved by a combination of the special warp inlay and the use of inherently non-elastic staple fibre yarns. High elasticity of this kind in the weft direction when using basically non-elastic yarns such as staple fibre yarns comprising cotton, viscose, polyacrylic, polyester, polyamide, polypropylene or mixtures thereof is completely surprising. A knitted fabric comprising staple fibre yarns of this kind combined with the special warp inlay has not as yet been devised as a fixing insert for the reinforcement of items of clothing. Rather, consideration was given in principle to the use of special yarns such as false-twist textured polyester yarns, that is materials, which are inherently elastic. In order to achieve even higher elasticity values, it is possible according to the invention, for example, to use two warp thread systems instead of the weft yarn of which one contains the described staple fibre yarns and the other comprises, for example, the conventionally used (false-twist) textured polyester yarns.

The following table shows the known weft insertion knitted fabrics in comparison to partial well fabrics with respect to well elasticity.

| | | | Weft |
|---|---|---|---|
| Type of knitted fabric | Inlay | Weft yarn | elasticity |
| Weft insertion | Open/closed | Staple fibre | 0-3% |
| | Fringe | yarn | |
| Weft insertion | Offset fringe, | Staple fibre | 5-10% |
| | tricot, Cloth | yarn | |
| Weft insertion | Open/closed | Textured | 12-20% |
| | Fringe | filament yarn | |
| Weft insertion | Offset fringe, | Textured | 15-20% |
| | tricot, cloth | filament yarn | |
| Partial weft | Open/closed | Staple fibre | Max 10% |
| | fringe | yarn | |
| Partial weft | Offset fringe, | Staple fibre | 25-50% |
| | tricot, cloth | yarn | |

It is also essential with the knitted fabric representing the substrate of the insert according to the invention that no separate weft yarn is used, but that at least one warp thread system is used as a well yarn replacement. More specifically, the thread system is inserted in the fabric in the transverse direction so that it is only held by other bonding elements and does not form loops of any kind. The at least one warp thread system, which serves as a weft yarn replacement is introduced into the knitted fabric as a partial weft.

With known raschel fixing inserts, the well is inserted by way of magazine well insertion means in the form of a well insertion. Production methods of this kind require specially made weft-insertion raschel machines which are very expensive. According to the invention, it is no longer necessary to use these kinds of special raschel machines. Instead, any conventional machine can be used to produce the knitted fabric, which also has the advantage of much greater variability in the choice of machines. Common machines of this kind only require approximately one third of the investment costs of said special well insertion raschel machines so that there are significant cost reductions in the production of the inserts according to the invention.

Dispensing with the insertion of the well thread over the entire width of the fabric enables high machine speeds to be achieved by using machines without a well insertion device.

According to the invention, a partial well inlay is used, wherein it has surprisingly been found that depending upon the stitch density, the partial well inlay used can correspond visually to a conventional well thread insertion over the entire width of the fabric. The partial well can theoretically take place up to below 10 needles. However, inlays up to below 5 needles, particularly preferably below 3 to up to below 5 needles are preferred. The stitch density is preferably 10-15 per cm.

In principle, it is possible to use known inlays such as open or closed fringe, offset fringe, cloth or tricot. Offset fringe, cloth or tricot are particularly preferred if particularly high elasticity values are to be achieved. Preferably, during the production of the knitted fabric used according to the invention, two to three guide bars are used, wherein machine gauges E12, E24, E28 or E 32 can be used. It is not compulsory for the guide needles to be fully drawn in (see examples).

The partial well system does not produce any coherence of the weft yarn over the entire width of the fabric. However, it has been established that this special inlay can achieve a very high degree of elasticity in both the transverse and the diagonal direction. If, as with the known raschel fabrics, a well insertion is threaded which comprises non-elastic yarn, this continuous weft has a blocking effect which is nowadays considered to be a drawback.

According to the invention, the known non-elastic staple fibre yarns such as viscose, cotton, polyacrylic, polyester, polyamide, polypropylene or even mixtures thereof can be used for the at least one warp thread system which replaces the weft yarn. In addition, the known (false-twist) textured polyester or polyamide filaments can also be used for the other warp thread systems which constitute the knitted fabric.

After the production of the raw knitted fabric, the non-elastic yarns of the warp thread system replacing the weft yarn can be napped in the usual way, for example by the use of nappers or emery paper. It is then possible to obtain a knitted fabric which is characterised not only by a high degree of elasticity, but also by a very soft textile feel.

According to the invention, it is therefore not necessary to use textured yarns that have to be produced by specific expensive technology. Even without the use of special yarns of this kind, the insert is endowed with a very soft and textile feel combined with a degree of elasticity in the weft direction which is to some extent even higher than the elasticity which could be achieved when using textured, in particular false-twist textured filament yarns.

The partial weft inlay furthermore produces a dense fabric surface, while on the other hand known raschel fabrics with a weft thread, threaded as a weft insertion, could have a more open appearance with a low weft density, which in fixed state could result in detrimental optical appearances in numerous outer fabrics, such as for example a ‘moiré effect’.

The threads which are used for the at least two warp thread systems have a fineness of from 15 to 80 dtex, preferably 15 to 125 dtex and particularly preferably 15 to 180 dtex. The different warp thread systems can comprise the same or even different materials. In particular, an inexpensive insert can be produced if polyester and/or polyamide is used as a conventional warp thread system and if, for example, a non-elastic material such as viscose, cotton or polyacrylnitrile is used as a warp thread system replacing the weft yarn used up to now. Preferably according to the invention, 2 to 3 warp thread systems are used.

The knitted fabric preferably has a weight of 15 to 125 g/m², wherein the weight of the insert can be higher or lower depending upon its intended purpose. For example, heavier inserts are preferably used for the reinforcement of shirt collars.

The invention also relates to a method for the production of an insert of this kind. The knitted fabric is produced in a conventional manner. The raw knitted fabric produced can then be subjected to a conventional washing and/or shrinking process. Heat and moisture can be used to achieve a shrinkage of the yarns and in this way to achieve a good degree of elasticity. Following this, optionally a dyeing process and thermostabilisation on a stenter frame are performed.

This raw knitted fabric is then coated using the conventional coating methods with an adhesive, preferably with a thermoplastic hot-melt adhesive or a reactive coating paste. The application can be performed in the conventional way in grid form, wherein the grid can be between 1 and 200 points per cm². Preferably grids between 40 and 150 points per cm² are used. The application of holt-melt adhesive is particularly preferably performed using the double-point coating method or powder-point method.

In order to achieve a particularly good feel, it is also possible to additionally perform a mechanical finishing operation, namely napping, for example by emerising. This is performed using a known emerising machine such as wool rollers or lattice rollers or napping machines, wherein the surface of the length of fabric is napped by friction on one or more emery rollers or by rolling with a wrapped card fillet.

The emerising process can be performed using both non-elastic and elastic threads for the warp thread systems. If filaments are used for the warp thread systems filaments, these are torn in numerous places by the napping process in order to obtain a fibrous pile of projecting fibre ends which is as dense and uniform as possible.

The napping process can be performed in different stages of the method. For example, it is possible to perform the napping process after the coating of the knitted fabric with the adhesive. In this case, some of the coating paste penetrates the threads of the insert and ensures additional stabilisation. For this reason, the fraying tendency is low.

It is obviously also possible to perform the napping process before the coating, for example after the production of the raw knitted fabric.

The additional dyeing process, which is performed optionally, is preferably performed before the thermostabilisation of the raw knitted fabric. Following this thermostabilisation, one side of the raw knitted fabric obtained is coated with the adhesive.

The material used for the thermoplastic adhesive paste is particularly preferably a hot-melt adhesive based on (co)polyamide, (co)polyester and (co)polyethylene or a mixture of said materials. The coating weight is generally 4 to 30 g/m², more preferably 6 to 25 g/m².

The following discloses a few particularly preferable examples of embodiments to explain the invention.

### EXAMPLE 1

GB1 and GB2 offset fringes, in counternotation

PES smooth dtex 33

Needle penetration: 1 full-1 empty

GB3: partial weft 00-44
CV Nm 34/1
Needle penetration: 1 full - 2 empty

Operations During Processing:
Napping/emerising
Finishing/thermofixing
Coating

### EXAMPLE 2

GB1 and GB2 offset fringe, in counternotation

PES smooth dtex 33

Needle penetration: 1 full-1 empty

GB3: partial weft 00-44
CV Nm 28/1
Needle penetration: 1 full - 2 empty

Operations During Processing:
Napping/emerising
Finishing/thermofixing
Coating

As is evident from the application examples, the knitted fabric is only produced from warp thread systems and hence dispenses with the use of weft threads. The inlaying of the warp thread systems takes place in the partial weft. This makes it possible in a simple and inexpensive way to produce an insert with a very good appearance and a very soft and textile feel with conventional materials and which in addition has a high degree of elasticity in the longitudinal and transverse direction and also in a diagonal direction.

1. An insert based on a knitted fabric as substrate with an adhesive layer applied to one side of the substrate, characterised in that the knitted fabric comprises at least two warp thread systems, wherein at least one warp thread system is inserted in the knitted fabric as a partial weft and contains staple fibre yarns.

2. An insert according to claim 1, characterised in that the partial weft takes place up to below ten needles.

3. An insert according to claim 1 or 2, characterised in that the staple fibre yarn of the warp thread system which is inserted in the partial weft contains viscose, cotton, polyacrylic, polyester, polyamide, polypropylene or a mixture thereof.

4. An insert according to any one of claims 1 to 3, characterised in that in addition to the staple fibre yarns, the at least one warp thread system which is inserted in the partial weft contains (false-twist) textured filaments.

5. An insert according to any one of claims 1 to 4, characterised in that the materials of the other warp thread systems are polyester, polyamide or also viscose, cotton, polyacrylic, polyamide, polypropylene or textured filaments or mixtures thereof.

6. An insert according to any one of claims 1 to 5, characterised in that the inlay of the knitted fabric is an offset fringe, tricot or cloth.

7. A method for the production of an elastic insert based on a knitted fabric as a substrate with an adhesive layer applied to one side of the substrate, by
a) the production of a raw knitted fabric
b) performance of a washing and/or shrinking process
c) optionally performance of a dyeing process
d) thermostabilisation of the raw knitted fabric
e) coating of one side of the raw knitted fabric obtained with an adhesive,
characterised in that the raw knitted fabric is produced from at least two warp thread systems, wherein at least one is inserted in the knitted fabric as a partial weft and contains staple fibre yarns.

8. A method according to claim 7, wherein a step for napping the raw knitted fabric takes place before or after the coating of the knitted fabric.

9. Use of a knitted fabric comprising at least two warp thread systems, wherein at least one warp thread system is inserted in a knitted fabric as a partial weft and contains staple fibre yarns for the creation of elastic fixing inserts for items of clothing.

10. Use according to claim 9, wherein the knitted fabric is used to reinforce the front part of items of clothing.

11. Use according to claim 9 for the reinforcement of collars and/or cuffs.
